(19) United States
(12) Patent Application Publication
(10) Pub. No.: US 2025/0202962 A1
(43) Pub. Date: Jun. 19, 2025

(54) INFORMATION PROCESSING APPARATUS, INFORMATION PROCESSING METHOD, INFORMATION PROCESSING SYSTEM, AND STORAGE MEDIUM

(71) Applicant: HONDA MOTOR CO., LTD., Tokyo (JP)

(72) Inventors: Taiki YAMADA, Tokyo (JP); Takuya OKADA, Tokyo (JP); Yuuki ABE, Tokyo (JP); Shunsuke UEKUSA, Tokyo (JP)

(21) Appl. No.: 18/971,576

(22) Filed: Dec. 6, 2024

(30) Foreign Application Priority Data
Dec. 14, 2023 (JP) 2023-211493

(51) Int. Cl. H04L 65/61; G06F 21/62

(52) U.S. Cl. CPC H04L 65/61; G06F 21/62

(57) ABSTRACT

An information processing apparatus stores access information for audio content to be provided from an external server for content provision, in association with information of an access condition for the audio content and acquires position information of a communication terminal used by a user. The apparatus specifies the audio content that provides the communication terminal with access, based on the access condition for the audio content and provides the communication terminal with content information including the access information associated with the audio content specified.

### CROSS-REFERENCE TO RELATED APPLICATION(S)

This application claims priority to and the benefit of Japanese Patent Application No. 2023-211493, filed Dec. 14, 2023, the entire disclosure of which is incorporated herein by reference.

### BACKGROUND OF THE INVENTION

### Field of the Invention

The present invention relates to an information processing apparatus, an information processing method, an information processing system, and a storage medium.

### Description of the Related Art

For the purpose of sightseeing guidance or the like, there has been conventionally known a technique of generating audio content corresponding to text content and transmitting the audio content to a terminal of a user, in a case where a position registered for the text content and a current position of the user become equal to or shorter than a certain distance (Japanese Patent Laid-Open No. 2016-40653).

These years, services of distributing audio content such as talks and programs over the Internet, like podcasts, are provided. Content creators of audio content upload their created content to such services, and provide the audio content via such services for users of such services.

A large number of pieces of audio content are provided from various distribution services. Hence, the users are able to enjoy the large number of pieces of audio content, but there is a problem that it is not easy for a user to find audio content suitable for them.

### SUMMARY OF THE INVENTION

The present invention has been made in view of the above problem, and enables a technique capable of providing users with appropriate content to be provided by content providing services.

In order to solve the aforementioned issues, one aspect of the present disclosure provides an information processing apparatus comprising: a storing unit configured to store access information for audio content to be provided from an external server for content provision, in association with information of an access condition for the audio content; an acquisition unit configured to acquire position information of a communication terminal used by a user; a specifying unit configured to specify the audio content that provides the communication terminal with access, based on the access condition for the audio content; and a providing unit configured to provide the communication terminal with content information including the access information associated with the audio content specified.

Another aspect of the present disclosure provides an information processing method performed in an information processing apparatus including a storing unit configured to store access information for audio content to be provided from an external server for content provision, in association with information of an access condition for the audio content, the information processing method comprising: acquiring position information of a communication terminal used by a user; specifying the audio content that provides the communication terminal with access, based on the access condition for the audio content; and providing the communication terminal with content information including the access information associated with the audio content specified.

Still another aspect of the present disclosure provides an information processing system comprising an information processing apparatus and a communication terminal used by a user, wherein the information processing apparatus includes: a storing unit configured to store access information for audio content to be provided from an external server for content provision, in association with information of an access condition for the audio content; an acquisition unit configured to acquire position information of a communication terminal used by a user; a specifying unit configured to specify the audio content that provides the communication terminal with access, based on the access condition for the audio content; and a providing unit configured to provide the communication terminal with content information including the access information associated with the audio content specified, and wherein the communication terminal includes: a transmission unit configured to transmit position information of the communication terminal to the information processing apparatus; and display the content information of the audio content to be provided from the information processing apparatus on a display unit, and start reproducing the audio content of the external server.

Yet another aspect of the present disclosure provides a non-transitory computer-readable storage medium storing instructions for causing a computer to perform an information processing method in which an information processing apparatus includes a storing unit configured to store access information for an audio content to be provided from an external server for content provision, in association with information of an access condition for the audio content, the method comprising: acquiring position information of a communication terminal used by a user; specifying the audio content that provides the communication terminal with access, based on the access condition for the audio content; and providing the communication terminal with content information including the access information associated with the audio content specified.

According to the present invention, it becomes possible to provide users with appropriate content to be provided by content providing services.

### BRIEF DESCRIPTION OF THE DRAWINGS

FIG. 1 is a diagram for describing an information processing system according to the present embodiment;

FIG. 2 is a block diagram illustrating a functional configuration example of the information processing apparatus according to the present embodiment;

FIG. 3 is a block diagram illustrating a functional configuration example of a communication apparatus according to the present embodiment;

FIG. 4A is a diagram for describing an example of content information according to the present embodiment;

FIG. 4B is a diagram for describing an example of operation history information according to the present embodiment;

FIG. 5 is a flowchart illustrating a series of operations of content selection processing according to the present embodiment;

FIG. 6 is a flowchart illustrating a series of operations of content display processing according to the present embodiment;

FIG. 7A is a diagram illustrating a screen example for displaying information of audio content that is being reproduced according to the present embodiment;

FIG. 7B is a diagram illustrating a screen example of further displaying a list of pieces of audio content according to the present embodiment;

FIG. 7C is a diagram illustrating a screen example for displaying detailed information of specific audio content according to the present embodiment;

FIG. 7D is a diagram illustrating an example of a notification displayed on a lock screen according to the present embodiment;

FIG. 8 is a flowchart illustrating a series of operations including registration of the audio content according to the present embodiment; and

FIG. 9 is a diagram illustrating an example of content information of the audio content according to the present embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Configuration of Information Processing System>

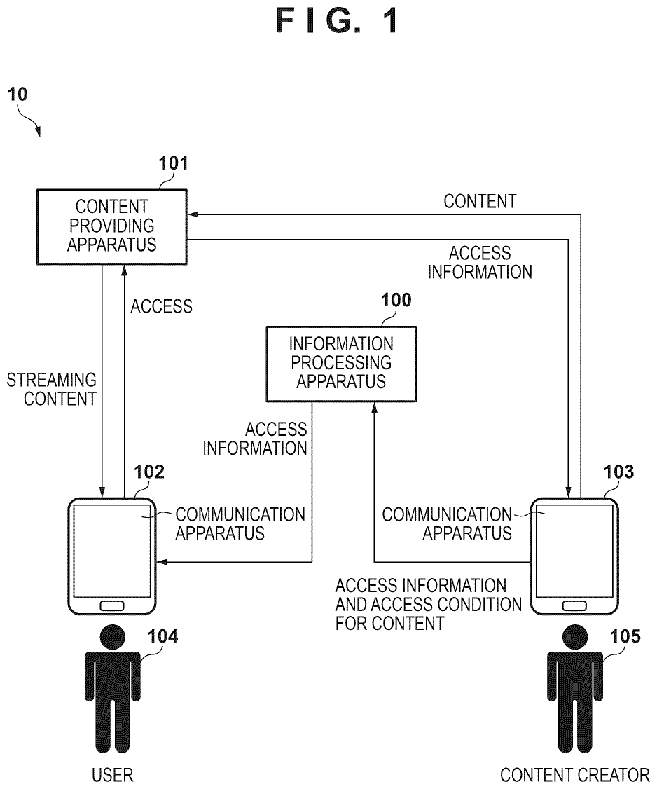

An information processing system according to the present embodiment will be described with reference to FIG. 1. An information system 10 includes, for example, an information processing apparatus 100, a content providing apparatus 101, a communication apparatus 102, and a communication apparatus 103. The communication apparatus 102 or the communication apparatus 103 is capable of communicating with the information processing apparatus 100 and the content providing apparatus 101 on wireless communication or through the Internet.

The communication apparatus 102 is a communication terminal used by a user 104, who is a listener of audio content, and examples include a smartphone, a personal computer, and a tablet terminal. By using the communication apparatus 102, the user 104 accesses the content providing apparatus 101, and streaming-reproduces the audio content.

The communication apparatus 103 is a communication terminal used by a content creator 105, and examples include a smartphone, a personal computer, and a tablet terminal. By using the communication apparatus 103, the content creator 105 sets, in the information processing apparatus 100, access information for a creator's own audio content stored in the content providing apparatus 101 and an access condition for that audio content.

The content providing apparatus 101 is, for example, a server configured on a cloud service, stores the audio content that has been created by the content creator 105, and distributes (for example, by streaming) the audio content to the communication apparatus 102 of the user 104.

The information processing apparatus 100 is, for example, a server configured on a cloud service, and provides a service (a content selection service) for selecting and providing the communication apparatus 102 with an appropriate audio content. Although details of the content selection service will be described later, the information processing apparatus 100 transmits access information of an audio content to the communication apparatus 102, which satisfies the access condition that has been set by the content creator 105. This enables the communication apparatus 102 to access the content providing apparatus 101, based on the access information from the information processing apparatus 100, and to reproduce an audio content suitable for the position of the communication apparatus 102 (or the position designated by the user 104 of the communication apparatus 102).

In the following description, as one example, a case where the user 104, who is carrying the communication apparatus 102, is driving a vehicle and an application for receiving a content providing service is executed in the communication apparatus 102 will be described. For example, when the user 104, who is driving the vehicle, moves, an audio content corresponding to the position of the user 104 (that is, the position of the communication apparatus 102) is provided by the content selection service. The communication apparatus 102 may provide information of audio content inside the vehicle in cooperation with an in-vehicle apparatus, or may be incorporated in the in-vehicle apparatus.

The content selection service to be provided by executing a computer program in the information processing apparatus 100 is managed by, for example, a service provider that provides the content selection service. The information processing apparatus 100 as hardware may be managed by the service provider, or may be managed by another business entity that operates a data center or the like. Note that a function achieved by the information processing apparatus 100, to be described later, may also be implemented in an edge node that can be arranged between a server and a communication apparatus. That is, the edge node may also be an example of the information processing apparatus.

In the description in the present embodiment, a case of using a service for distributing audio content is given as an example. However, the present embodiment is also applicable to a case of distributing video content or a document content.

### <Configuration of Information Processing Apparatus>

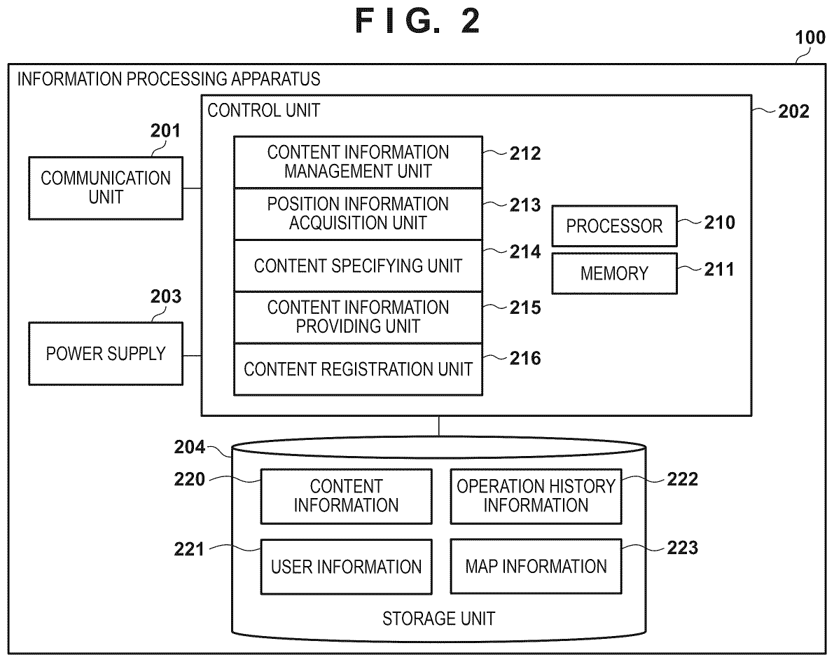

Next, a functional configuration example of the information processing apparatus 100 will be described with reference to FIG. 2. Note that each of functional blocks to be described with reference to the attached drawings may be integrated, or may be separated. In addition, a function to be described may be implemented in another block. In addition, a functional block to be described as hardware may be implemented on software, and vice versa. Furthermore, in the present embodiment, a case where the information processing apparatus 100 is a single apparatus will be described as an example, but the information processing apparatus 100 may include a plurality of apparatuses, or may be configured as one or more virtual machines.

A communication unit 201 includes a communication circuit or a communication module capable of communicating with the communication apparatus 102 through a network.

A control unit 202 includes a processor 210 and a memory 211. The processor 210 may include one or more processors. By causing the processor 210 to execute a computer program stored in a memory 211 or a storage unit 204, the control unit 202 controls operations of each unit of the information processing apparatus 100. In addition, the functions of each unit included in the control unit 202 are achieved by, for example, the processor 210 executing a computer program.

The memory 211 is, for example, a volatile storage medium such as a DRAM, and temporarily stores parameters, processing results, and the like so that the control unit 202 executes the computer program. A power supply unit 203 is a power supply for supplying electric power for operating each unit of the information processing apparatus 100.

The storage unit 204 includes, for example, a non-volatile storage medium such as a hard disk or a semiconductor memory, and stores setting values necessary for the operation of the information processing apparatus 100, computer programs, and the like. The computer programs stored in the storage unit 204 include an operating system and various applications for achieving various functions of the information processing apparatus 100. The storage unit 204 includes, for example, content information 220, user information 221, operation history information 222, map information 223, and the like.

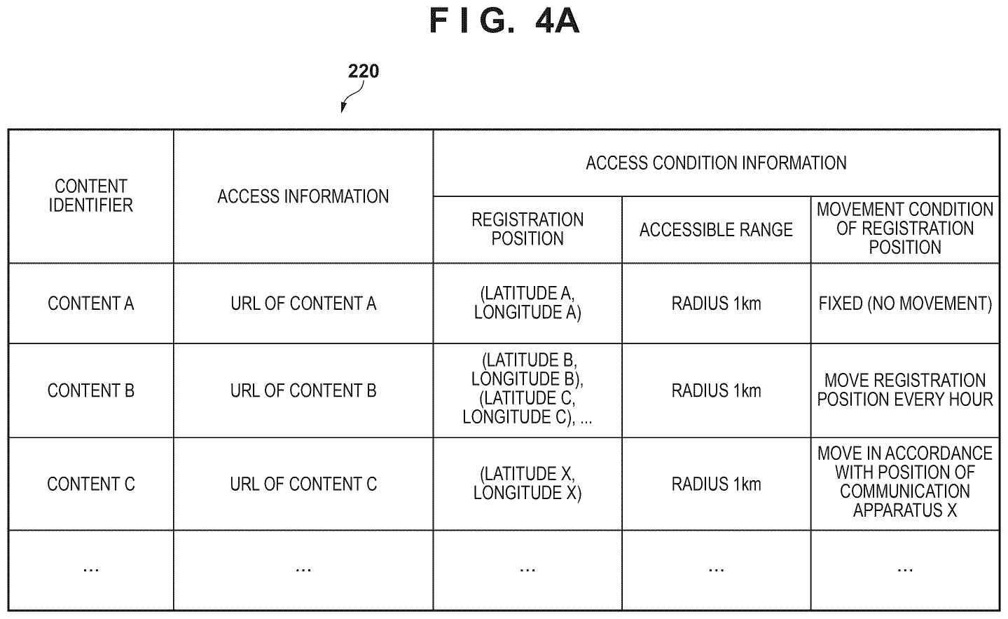

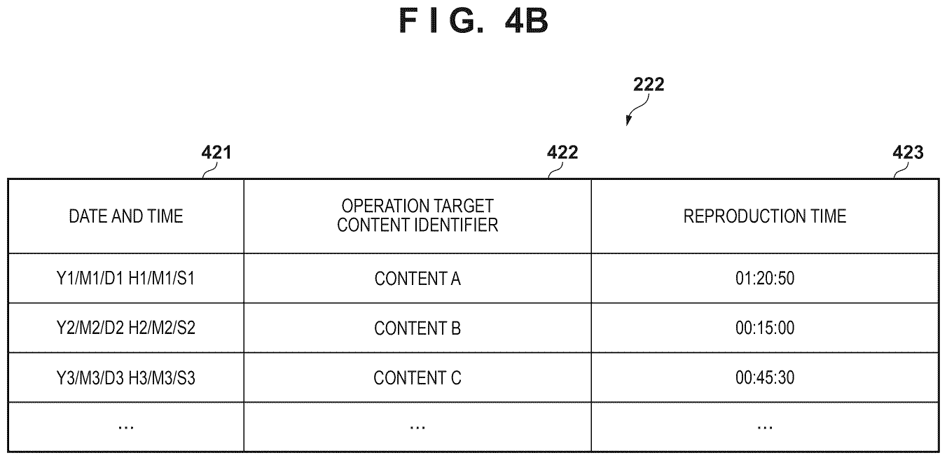

As illustrated in FIG. 4A, for example, the content information 220 includes access information for audio content stored in the content providing apparatus 101 and information of an access condition for that audio content. The access information is information for an external device to access the audio content to be provided by the content providing apparatus 101. The access information may include, for example, a URL of the audio content, without being limited to this. It is sufficient if the access information includes information that enables an external device to access the audio content to be provided by the content providing apparatus 101, and examples may include an RSS feed including information that enables access to the audio content.

In addition, the access information is based on information that has been provided by the content providing apparatus 101 for the communication apparatus 103 (which is used by the content creator 105), and has been transmitted from the communication apparatus 103 to the information processing apparatus 100. That is, the access information is information set by the content creator 105 to the audio content in the communication apparatus 103.

Access condition information includes a condition of the communication apparatus 102, which is to access the audio content. For example, with the access condition information, it is possible to define a range of the position of the communication apparatus 102, which is to access the audio content. For example, the access condition information for the audio content includes position information (a registration position) set to audio content, and it is possible to set for the audio content to be provided for the communication apparatus 102, which is present in a range (accessible range) determined by the size of a predetermined radius centering around such a registration position.

The access condition information can further include a movement condition of the registration position. For example, in a case where the movement condition of the registration position is set to “fixed”, the registration position does not change. For example, in a case where the registration position set to the audio content is (latitude A, longitude A), the registration position is (latitude A, longitude A) even after a lapse of time.

As another example, in a case where the movement condition of the registration position is set to, for example, “move the registration position every hour”, the registration position is changed every hour. For example, the registration position set to the audio content may include a plurality of registration positions such as {(latitude B, longitude B), (latitude C, longitude C), . . . }, and the registration position may change among the registration positions every hour. The registration position may be changed sequentially or randomly.

As still another example, in a case where the movement condition of the registration position is set to “move in accordance with the position of a communication apparatus X”, for example, the registration position may be associated with the position of the communication apparatus 103 of the content creator 105, and may move in accordance with the position of the communication apparatus 103. In such a setting of the registration position, the user 104 moves following the content creator 105, who is transmitting the information. Thus, it becomes possible to provide an enjoyable listening experience, by following audio content and acquiring the audio content transmitted by the content creator 105.

Note that in order to facilitate understanding of embodiments, a case where the size of a radius indicating the accessible range is the same (for example, a radius of 1 km) for all the contents will be described as an example. However, the accessible range may be separately set to every audio content in accordance with details of the audio content, an intention of distribution, the registration position, the above-described movement condition, or the like. For example, with regard to the accessible range, the radius of 1 km may be set to content A, and the radius of 500 m may be set to content B. By setting in this manner, it is possible for users who are listening to the content B to feel that they are approaching and following the moving registration position. Furthermore, a radius of 100 m may be set to content C. By setting in this manner, it is possible to provide users who are listening to the content C with opportunity to listen to audio content while getting closer to a range where a person who is carrying the communication apparatus X can be seen.

The user information 221 includes information of the user 104, who is a user of the system. The user information 221 includes a user identifier, authentication information for using the content selection service, and the like.

The operation history information 222 is information indicating an operation history of audio content of every user 104 and acquired from the communication apparatus 102. For example, as illustrated in FIG. 4B, the operation history information 222 includes a date and time 421, an operation target content identifier 422, and a reproduction time 423. The date and time 421 indicates a date and time when target audio content is operated. The operation target content identifier 422 is an identifier of the audio content that has been operated by the user 104. The reproduction time 423 indicates how long the user 104 has reproduced the target audio content. For example, it is possible to calculate the reproduction time 423 from a reproduction start time and a reproduction end time, and to determine completion of the reproduction. Note that without being limited to the length of time, the reproduction time 423 may be information indicating what percentage of the audio content has been reproduced with respect to the length of the audio content. In addition to the information illustrated in FIG. 4B, the operation history information 222 may include any other piece of information, such as a frequency at which the user 104 stops reproducing the audio content or a reproduction speed at the time of reproduction.

The map information 223 includes information of roads, railway lines, facilities such as buildings and stores, addresses, latitudes, longitudes, and altitudes. For example, the information processing apparatus 100 may provide the communication apparatus 102 of the user 104 (or the communication apparatus 103 of the user 105) with map information to cause the communication apparatus 102 to display a map. The provision of the map information enables the communication apparatus 102 to visually display the positional relationship between the position of the user 104 and the position information set to the audio content.

A content information management unit 212 manages the access information for the audio content provided by the content providing apparatus 101 in association with the information of the access condition for the audio content. For example, the content information management unit 212 acquires the access information and the access condition information for the audio content from a content registration unit 216, associates the access information and the access condition information with each other, and thus generates or updates the content information 220.

The content information management unit 212 is capable of registering the audio content that has been designated by the user 104 on the communication apparatus 102, as favorite audio content. The content information management unit 212 may manage favorite content registered for every user, by using another table for managing the information of favorites for every user.

A position information acquisition unit 213 acquires the position information of the communication apparatus 102 from the communication apparatus 102, which is used by the user 104. The position information of the communication apparatus 102 includes, for example, information of latitude and longitude of the communication apparatus 102 to be obtained by GPS inside the communication apparatus 102. The position information of the communication apparatus 102 may include information of the latitude, the longitude, and the altitude. As another example, the position information acquisition unit 213 may further acquire, from the communication apparatus 102, a designated position (for example, information of the latitude and the longitude) on a map designated on the communication apparatus 102.

A content specifying unit 214 specifies audio content that provides the communication apparatus 102 with access, based on the access condition for the audio content (of the content information 220). For example, in a case where the position of the communication apparatus 102 satisfies the access condition set to the audio content, the content specifying unit 214 specifies the audio content as the audio content that provides the communication apparatus 102 with access.

As an example, in a case where the position of the communication apparatus 102 is present within a predetermined distance from the registration position set to the audio content, the content specifying unit 214 determines that the position of the communication apparatus 102 satisfies the access condition set to the audio content.

As another example, in a case where a designated position designated on a map of the communication apparatus 102 is present within a predetermined distance from the registration position set to the audio content, the content specifying unit 214 determines that the position of the communication apparatus 102 satisfies the access condition set to the audio content.

Furthermore, the content specifying unit 214 is capable of considering the above-described movement condition of the registration position. For example, in a case where the movement condition of the registration position is set to “change the registration position every hour, and move”, the registration position is changed every hour. Then, in a case where the position of the communication apparatus 102 is present within a predetermined distance from the registration position, the content specifying unit 214 determines that the position of the communication apparatus 102 satisfies the access condition set to the audio content. In a case where the movement condition of the registration position is set to “move in accordance with the position of a communication apparatus X”, the content specifying unit 214 determines that the position of the communication apparatus 103 satisfies the access condition, for example, in a case where the position of the communication apparatus 102 is present within a predetermined distance from the position of the communication apparatus 102.

A content information providing unit 215 provides the communication apparatus 102 with access information that is associated with the audio content that has been specified by the content specifying unit 214. In providing the communication apparatus 102 with the access information, the content information providing unit 215 may provide the communication apparatus 102 with content information including the access information. The content information may include, for example, at least one of an episode name of audio content, detailed information, a thumbnail image, a name of a service that provides that audio content, a name of a channel in which that audio content is registered, a name of a creator that created that audio content, and the like.

In providing the content information, the content information providing unit 215 may provide the communication apparatus 102 with the position information set to the audio content that has been specified by the content specifying unit 214. In this situation, the content information providing unit 215 may provide the communication apparatus with map information including the position of the communication apparatus 102 out of pieces of the map information 223. In this manner, the communication apparatus 102 is capable of displaying a map around the communication apparatus 102, and is capable of superimposing and displaying the position information of the audio content on the map, so that the user 104 is able to visually grasp what type of audio content is registered around the place where the user itself is present.

In a case where the position information acquisition unit 213 acquires the designated position that has been designated on the communication apparatus 102, the content information providing unit 215 is capable of providing the communication apparatus 102 with the content information of the audio content included within a predetermined range from the designated position. In this manner, it becomes possible not only to acquire the audio content corresponding to the position where the user 104 is actually moving, but also to grasp the presence of the audio content to be provided around the designated position that has been designated by the user on the map displayed on the communication apparatus 102 and to reproduce the audio content.

In transmitting a plurality of pieces of access information for a plurality of pieces of audio content to the communication apparatus 102, the content information providing unit 215 provides the communication apparatus 102 with content information of the audio content prioritized in order of proximity to the above-described designated position or the position of the communication apparatus 102.

The content information providing unit 215 may infer audio content having a high priority for the user, based on information indicating an operation history of the audio content stored in the operation history information 222. For example, the content information providing unit 215 may select audio content or a genre of the audio content having a large number of reproduction times (or a long reproduction time in total) by the user, and then may infer audio content similar to or in the same genre as the selected content. In a case where no audio content included within a predetermined range from the above-described designated position is present, the content information providing unit 215 may provide the communication apparatus 102 with content information of inferred audio content. Furthermore, in a case where no audio content included within a predetermined range from the above-described designated position is present and no inferred audio content is present, the content information providing unit 215 may provide the communication apparatus 102 with content information of audio content in accordance with a ranking to be determined, based on operation histories of a plurality of users.

The content registration unit 216 acquires the access information and the access condition for the audio content from the communication apparatus 103, which is used by the content creator 105, and provides the content information management unit 212 with acquired information. This enables the content creator 105 to register for which user (for example, a user around a desired position) the audio content stored in the content providing apparatus 101 is to be provided. For example, in a case where a content creator creates audio content including a talk about a building or a store in a specific place, the access condition is set in accordance with the position of the user 104, so that the user 104 around the position related to the talk can easily access the audio content.

### <Configuration of Communication Apparatus>

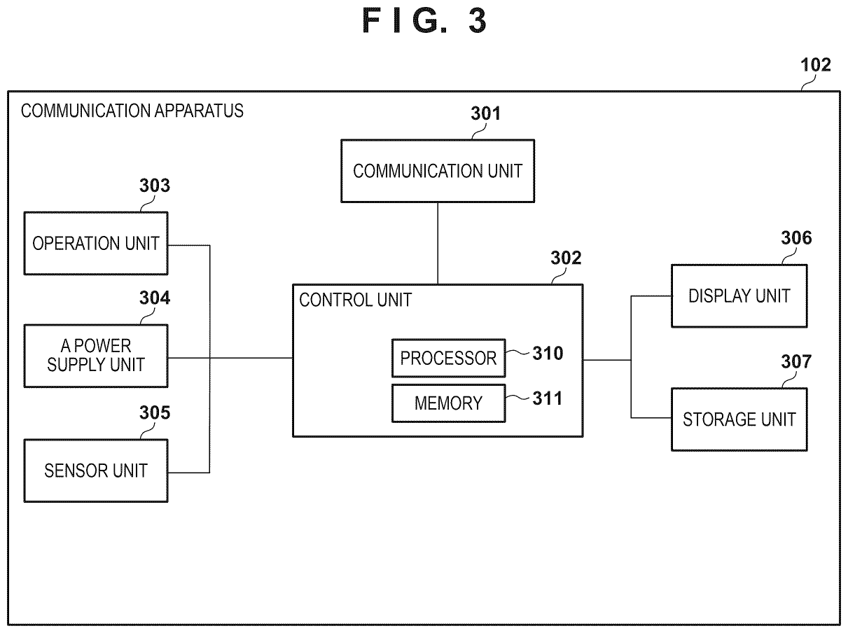

Next, a functional configuration example of the communication apparatus 102 will be described with reference to FIG. 3. Note that each of functional blocks to be described with reference to the following drawings may be integrated, or may be separated. In addition, a function to be described may be implemented in another block. In addition, a functional block to be described as hardware may be implemented on software, and vice versa.

A communication unit 301 includes, for example, a communication circuit or the like, and communicates with the information processing apparatus 100 or the content providing apparatus 101 by connecting to the Internet on mobile communication such as LTE or connecting to a network on wireless LAN communication, for example.

A control unit 302 includes a processor 310 and a memory 311. For example, by causing the processor 310 to execute a computer program stored in a storage unit 307, the control unit 302 controls operations of each unit of the communication apparatus 102. The processor 310 includes one or more processors, and the memory 311 includes a volatile memory, for example, a DRAM.

An operation unit 303 includes buttons and a touch panel included in the communication apparatus 102, and receives user operations on buttons and GUIs for various operations displayed on a display unit 306. A power supply unit 304 provides each unit of the communication apparatus 102 with electric power. A sensor unit 305 includes, for example, various sensors such as a GPS receiver, a gyro sensor, and an imaging element. The sensor unit 305 is capable of acquiring the position of the communication apparatus 102 from a GPS signal.

The display unit 306 includes, for example, a display device such as an LCD or an OLED. In response to an instruction from the control unit 302, the display unit 306 displays a GUI, based on the content information received from the information processing apparatus 100. The control unit 302 executes an application for the content selection service, and displays, on the GUI, the content information of the audio content that has been received from the information processing apparatus 100. Note that instead of using the application for the content selection service, the communication apparatus 102 may execute a web browser to display, on the GUI, the content information of the audio content that has been received from the information processing apparatus 100.

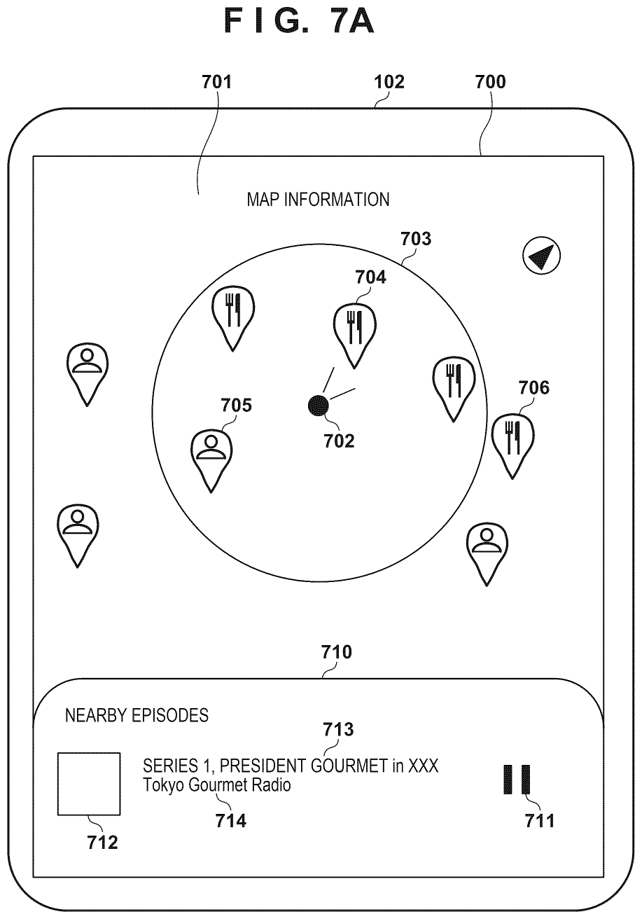

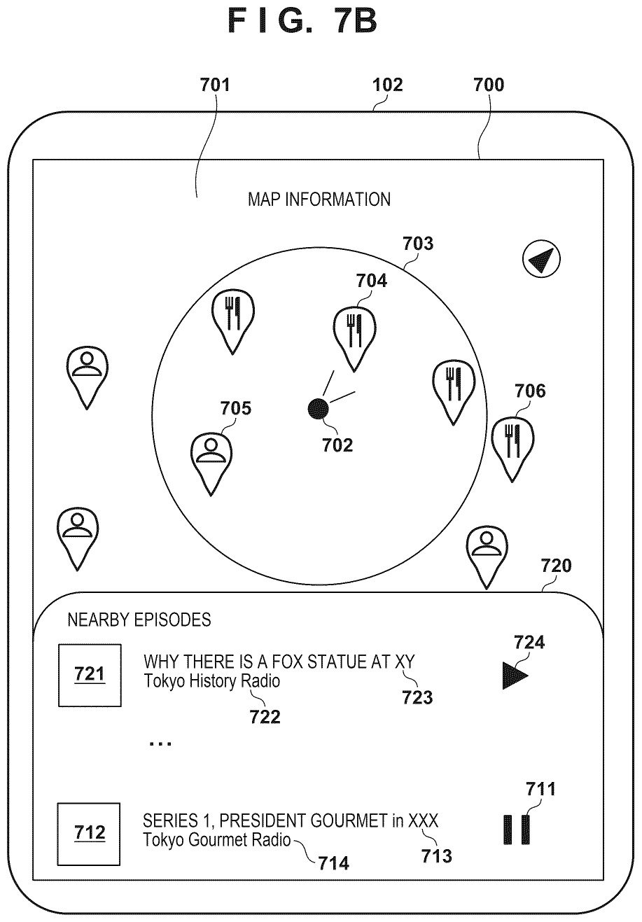

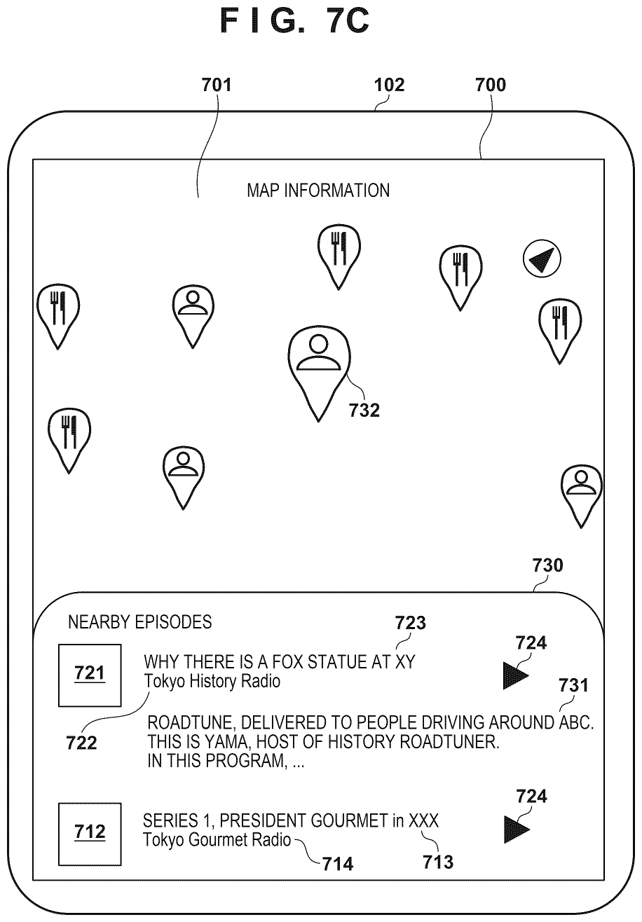

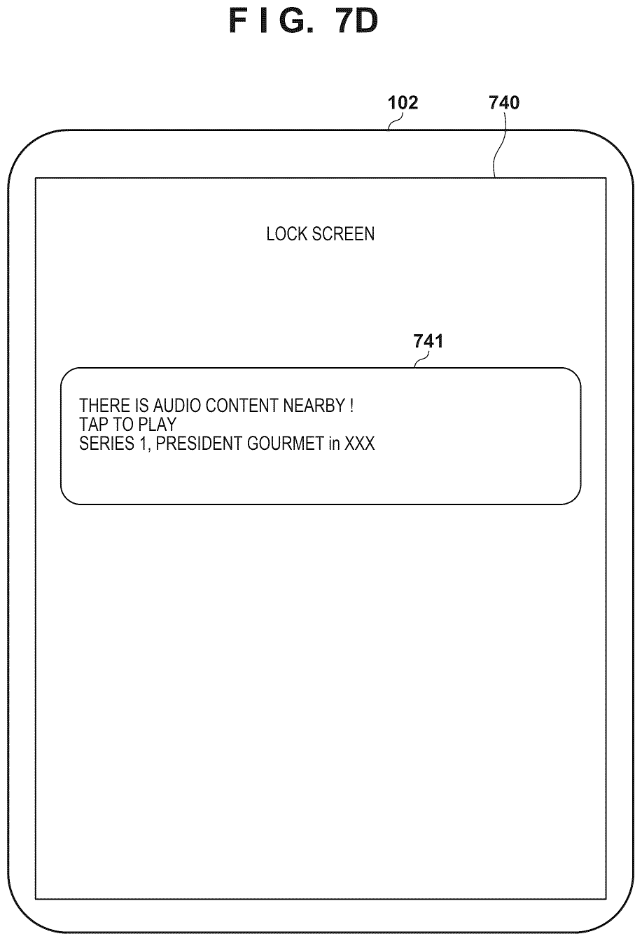

An example of the GUI to be displayed on the display unit 306 of the communication apparatus 102 will be described with reference to FIGS. 7A to 7D. Note that information displayed in FIGS. 7A to 7D may be included in, for example, content information received from the information processing apparatus 100, or may be information that has been acquired by the communication apparatus 102 from the content providing apparatus 101, based on access information from the information processing apparatus 100.

FIG. 7A illustrates an example of a screen 700, which displays information of audio content that is being reproduced. On the screen 700, information of audio content set to a position around the communication apparatus 102 is displayed in a first part in the screen, and the information of the audio content that is being reproduced is displayed in a second part in the screen.

On this screen 700, the communication apparatus 102 displays, for example, a current position 702 of the communication apparatus 102, a position to which the audio content is set, and a predetermined range 703 from the position of the communication apparatus 102 to be superimposed on map information 701. The communication apparatus 102 is capable of displaying an icon corresponding to classification of the audio content at the position to which the audio content is set. For example, a restaurant icon 704 indicates that audio content set to the position relates to, for example, restaurant information. In addition, a human icon 705 indicates that audio content set to the position is, for example, a talk by a specific person. A restaurant icon 706 indicates that audio content set to the position is related to restaurant information. The restaurant icon 706 is outside the predetermined range 703, and thus may be displayed in a mode (for example, in a grayed-out state) different from the restaurant icon 704, which is displayed within the predetermined range 703. The predetermined range 703 enables the user to intuitively understand that the audio content set within the range is to be provided for the communication apparatus 102.

In addition, the communication apparatus 102 displays information of content that is being reproduced in a region 710. The information of the content that is being reproduced includes an operation button 711 for the audio content, a thumbnail image 712 of the audio content, a title 713 of the audio content, and audio content providing source 714.

FIG. 7B illustrates a screen example in a case where a list of pieces of audio content set to positions around the communication apparatus 102 is further displayed, in addition to the information of the content that is being reproduced. In FIG. 7B, a list of pieces of audio content at positions different from that of the audio content that is being reproduced is displayed in a region 720. The audio content in the list are, for example, audio content set to positions inside the predetermined range 703. Information of audio content in the list includes a thumbnail image 721, an audio content providing source 722, a title 723 of the audio content, and an operation button 724, for the audio content. Displaying such a GUI enables the user to easily check what types of audio content are set to surrounding positions. In addition, when the user finds audio content more interesting than the audio content that is being reproduced, the user is able to easily start reproducing other audio content.

FIG. 7C illustrates a screen example of displaying detailed information of specific audio content. The screen illustrated in FIG. 7C is displayed, for example, when the user presses a detail display button, not illustrated, on the screen illustrated in FIG. 7B. The communication apparatus 102 displays detailed information 731 in a region 730, in addition to the information of the audio content illustrated in FIG. 7B. The detailed information 731 may include, for example, text information including description about the audio content, an image, a link to an SNS or a web page, and the like. Note that instead of displaying the text information in the region 730, the detailed information 731 may be read by sounds of voices. In this case, the user in the vehicle is able to easily know what the content is without reading the text related to the detailed information.

FIG. 7D illustrates an example of a notification displayed on a lock screen 740 of the communication apparatus 102, before the screen 700 illustrated in FIG. 7A is displayed. For example, when receiving the access information for the audio content from the information processing apparatus 100, the communication apparatus 102 is capable of displaying a notification 741 for notifying of the presence of the audio content (for example, on the lock screen 740). The notification 741 includes a message for notifying that there is audio content set around the communication apparatus 102. When the user taps the notification 741, the communication apparatus 102 causes the screen display to transition to, for example, the above-described screen 700 of FIG. 7A.

Note that in the above description of FIGS. 7A to 7D, the case where the current position 702 of the communication apparatus 102 is used has been described as an example. However, instead of the current position 702, the position (designated position) that has been designated by the user on the map information may be used. In this case, the predetermined range 703 indicates a predetermined range from the designated position, and information of the audio content set to a position around the designated position is displayed in the map information, in the region 710, in the region 720, and in the region 730.

A description will be given with reference to FIG. 3 again. The storage unit 307 includes, for example, a non-volatile memory such as a semiconductor memory, and stores programs to be executed by the control unit 302 and setting values. The computer program stored in the storage unit 307 includes various applications including an operating system for achieving various functions of the communication apparatus 102 and an application for the above-described content selection service.

### <Series of Operations of Content Selection Processing in Information Processing Apparatus>

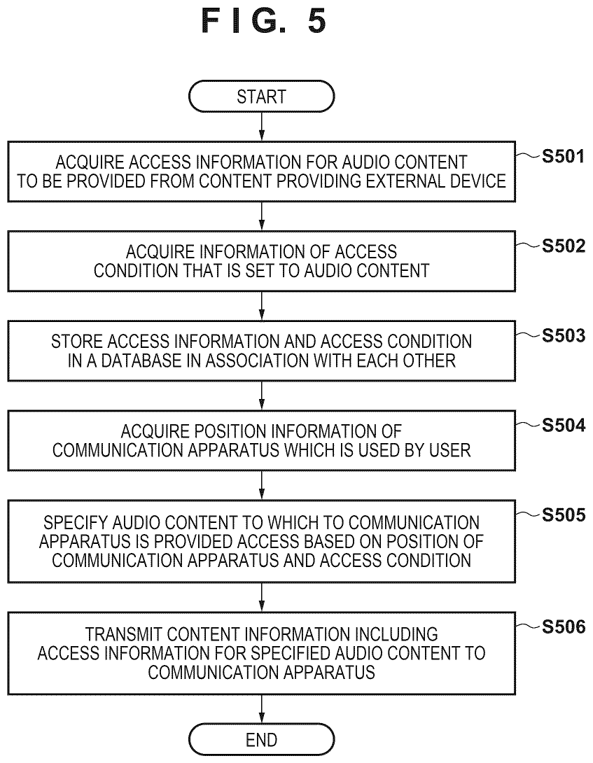

Next, a series of operations of content selection processing performed in the information processing apparatus 100 will be described with reference to FIG. 5. The present processing is achieved by the processor 210 of the control unit 202 executing a computer program stored in the storage unit 204.

In S501, the content registration unit 216 acquires, from the communication apparatus 103 of a content creator, the access information for the audio content to be provided from the content providing apparatus 101. The access information for the audio content is the information that has been described with reference to FIG. 4A, and is, for example, a URL of the audio content or an RSS feed including information accessible to the audio content. In S502, the information of the access condition set to the audio content is acquired from the communication apparatus 103. The information of the access condition is the information that has been described with reference to FIG. 4A.

In S503, the content information management unit 212 stores the access information acquired in S501 and the access condition acquired in S502 in a database (the content information 220 of the storage unit 204) in association with each other. In S504, the position information acquisition unit 213 acquires the position information of the communication apparatus 102, which is used by the user 104. In S505, the content specifying unit 214 specifies the audio content that provides the communication apparatus 102 with access, based on the position of the communication apparatus 102 and the access condition. The content specifying unit 214 specifies the audio content in the processing example that has been described with reference to FIG. 2. In S506, the content information providing unit 215 provides the communication apparatus 102 with the content information including the access information for the specified audio content in the processing example that has been described with reference to FIG. 2.

### <Series of Operations of Content Display Processing in Communication Apparatus>

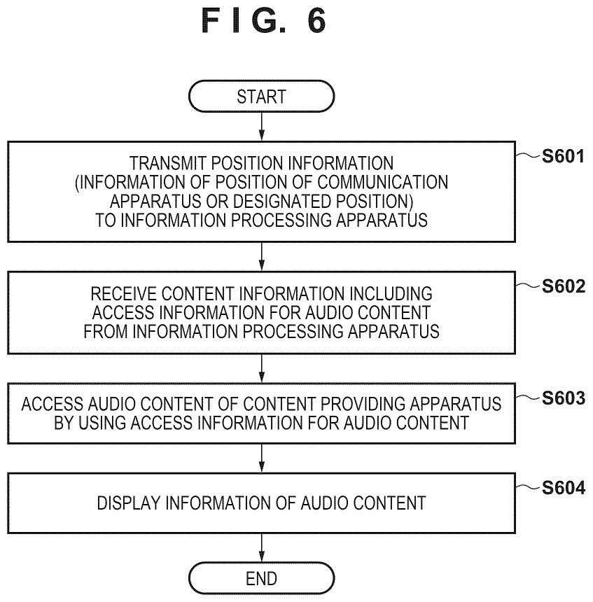

Next, a series of operations of content display processing performed in the communication apparatus 102 will be described with reference to FIG. 6. The present processing is achieved by the processor 310 of the control unit 302 executing a computer program stored in the storage unit 307.

In S601, the control unit 302 transmits the position information (the information of the position of the communication apparatus 102 or the designated position that has been designated on the communication apparatus 102) to the information processing apparatus 100. In S602, the control unit 302 acquires the content information including the access information for the audio content from the information processing apparatus 100. The content information including the access information transmitted from the information processing apparatus 100 is the content information to be provided by the content information providing unit 215, which has been described with reference to FIG. 2.

In S603, the control unit 302 accesses the audio content of the content providing apparatus 101, by using the access information for the audio content. As described above, the access information acquired from the information processing apparatus 100 includes, for example, a URL for accessing the content providing apparatus 101, and thus the control unit 302 accesses the audio content, by using, for example, the URL.

In S604, the control unit 302 acquires the information of the audio content from the content providing apparatus 101, and displays the information of the audio content on the display unit 306. For example, the control unit 302 may display the notification illustrated in FIG. 7D. Alternatively, the control unit 302 may acquire map information related to the audio content, information of the audio content set to the position of the communication apparatus 102 or the position around the designated position, and the like, from the information processing apparatus 100, and may display the screen 700 illustrated in FIG. 7A. The control unit 302 may further start streaming the audio content.

### <Series of Operations Including Registration of Audio Content in Information Processing Apparatus>

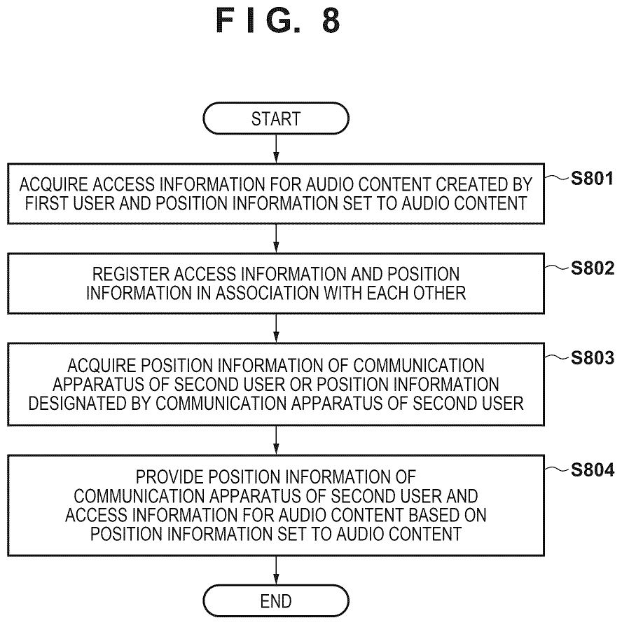

Next, a series of operations including registration of audio content in the information processing apparatus 100 will be described with reference to FIG. 8. The present processing is achieved by the processor 210 of the control unit 202 executing a computer program stored in the storage unit 204.

In S801, the content registration unit 216 acquires the access information for the audio content that has been created by the content creator 105 and the position information set to the audio content. The access information for the audio content that has been created by the content creator 105 is access information to access the above-described content providing apparatus 101.

In S802, the content registration unit 216 registers the access information for the audio content and the position information in association with each other, as the content information 220, which has been described with reference to, for example, FIG. 4A. The content creator 105 is able to set an access condition, such as a movement condition of the above-described registration position. In addition, the content registration unit 216 is capable of updating the position information set to the audio content, based on new position information from the communication apparatus 103 of the content creator 105. That is, the content creator 105 is able to change the position information that has been set to the audio content. For example, in a case where restaurant information of a store is set to the position of such a store in the map information, it is possible to change the registration position of the audio content, when the store is moved. Alternatively, the content creator 105 is able to change the registration position to a position that increases contact with users more than a position that has been set.

Note that as described above with reference to FIG. 4A, the content registration unit 216 is capable of registering the position of the communication apparatus 103 of the content creator 105 in association with the position information set to the audio content. In this manner, the position where it is possible to listen to the audio content changes in accordance with a movement of the content creator 105. Thus, it becomes possible to provide the audio content that other users cannot know when they will come across, so that the audio content can be diversified. Furthermore, as described above with reference to FIG. 4A, the content registration unit 216 is capable of registering a plurality of pieces of position information as the position information set to the audio content. By enabling the plurality of pieces of position information to be set to the audio content, the content creator 105 is able to obtain an opportunity to have the audio content listened to at a plurality of positions. Furthermore, the content registration unit 216 is capable of registering the position information set to the audio content so that the position information is sequentially changed among the plurality of pieces of position information. For example, the content creator 105 is able to register, for audio content, position information that moves around along a certain route over a certain time. The information processing apparatus 100 is capable of providing the user who listens to the audio content with a new listening experience of listening to the audio content while moving along the route. The content registration unit 216 may further register a plurality of pieces of audio content that have been created by the content creator 105 in association with each other. This enables, for example, provision of a listening experience like a tour of sequentially listening to a plurality of continuous pieces of audio content connected in a row, while moving. For example, in a case where audio content is set to every station of a predetermined railway route, the user 104 is able to sequentially listen to the audio content in accordance with a movement, while moving through a station of the railway route.

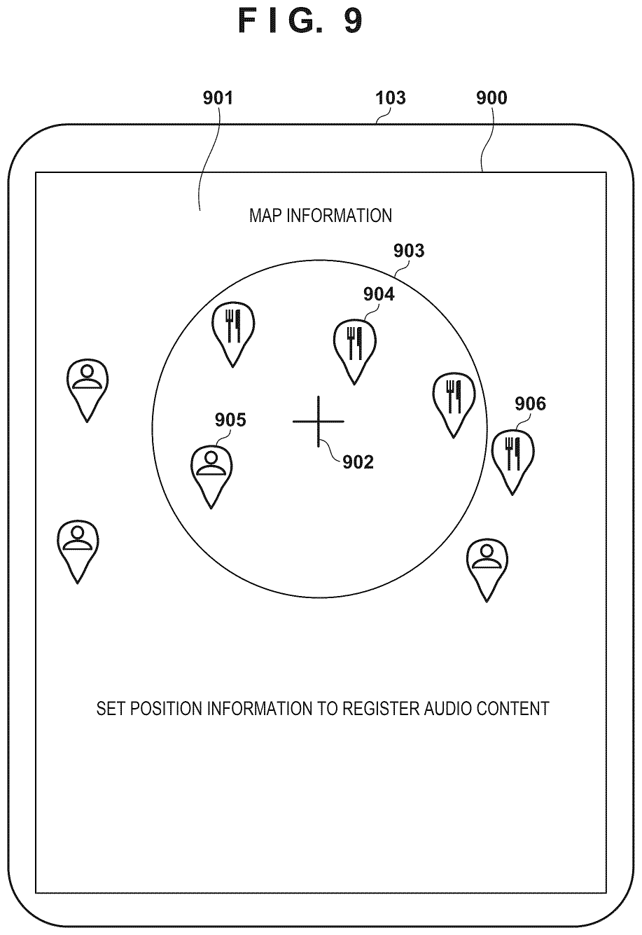

Note that before registering the audio content, the information processing apparatus 100 may cause the content information providing unit 215 to acquire the position information set to the audio content, and to provide the communication apparatus 103 with the content information of the audio content of another user set to a position within a predetermined distance from the position information. For example, when acquiring the position information set to the audio content from the communication apparatus 103, the content information providing unit 215 can provide the communication apparatus 103 with the content information of the audio content illustrated in FIG. 9. FIG. 9 illustrates an example in which an example of the content information is displayed on map information 901 on a screen 900 of the communication apparatus 103. For example, upon receipt of the position information, the content information providing unit 215 provides the communication apparatus 103 with information indicating the positions of the audio content of other users (examples including 904, 905, and 906) set to positions included within a predetermined distance from the position 902, which is indicated by the position information. In this situation, information 903, which serves as a scale of the distance, may be added. By referring to such a screen 900, the content creator 105 is able to consider to which position the audio content is to be set.

In S803, the information processing apparatus 100 acquires, from the communication apparatus 102, the position information of the communication apparatus 102 of the user 104, who is different from the content creator 105, or the position information that has been designated by the communication apparatus 102. In S804, the information processing apparatus 100 provides the communication apparatus 102 with the access information for the audio content, based on the position information from the communication apparatus 102 and the position information set to the audio content. Note that the processing of S803 and S804 may be similar to S504 to S506 in the series of operations illustrated in FIG. 5.

As described heretofore, the information processing apparatus 100 stores the access information for the audio content provided by the content providing apparatus 101 in association with the information of the access condition for the audio content, and acquires the position information of the communication apparatus from the communication apparatus 102, which is used by the user. Then, the information processing apparatus 100 specifies the audio content to which access is provided to the communication apparatus 102, based on the access condition for the audio content, and provides the communication apparatus 102 with the content information including the access information that is associated with the specified audio content. In this manner, it becomes possible to, out of the content to be provided by the content providing service, provide the user with appropriate content.

In addition, the information processing apparatus 100 registers an audio content that is to be provided by the content providing apparatus 101 and that has been created by the content creator 105, acquires the position information from the communication apparatus 102, which is used by the user 104, and provides the communication apparatus 102 with the content information including the access information for the audio content. In this situation, the information processing apparatus 100 acquires and registers the access information for the audio content and the position information set to the audio content from the communication apparatus 103, and provides the communication apparatus 102 with the content information including the access information for the audio content, based on the position information from the communication apparatus 102 and the position information that has been set to the audio content. In this manner, the content creator is able to increase an opportunity to provide content to be provided by the content providing service for a user suitable for that audio content.

In addition, by providing the user 104 with appropriate audio content according to the above-described embodiment, thereby enabling the user 104 to suppress the number of content search times for searching for desired content. That is, this also leads to a reduction of a processing load on the server for searching for content.

### Summary of Embodiments

In the above-described embodiments, the information processing apparatus, the information processing method, the information processing system, the program, and the storage medium in the following are provided.

### (Item 1-1)

An information processing apparatus comprising:
a storing unit configured to store access information for audio content to be provided from an external server for content provision, in association with information of an access condition for the audio content;
an acquisition unit configured to acquire position information of a communication terminal used by a user;
a specifying unit configured to specify the audio content that provides the communication terminal with access, based on the access condition for the audio content; and
a providing unit configured to provide the communication terminal with content information including the access information associated with the audio content specified.

### (Item 1-2)

The information processing apparatus according to item 1-1, wherein
the information of the access condition for the audio content includes position information set to the audio content, and
the providing unit provides the communication terminal with the position information set to the audio content specified.

### (Item 1-3)

The information processing apparatus according to item 1-2, wherein the providing unit provides the communication terminal with the content information of the audio content, the access condition for which is satisfied by a position of the communication terminal.

### (Item 1-4)

The information processing apparatus according to item 1-2, wherein
the acquisition unit further acquires, from the communication terminal, a designated position designated on the communication terminal, and
the providing unit provides the communication terminal with the content information of the audio content included within a predetermined range from the designated position.

### (Item 1-5)

The information processing apparatus according to item 1-4, wherein the providing unit provides the communication terminal with the content information of audio content prioritized in order of proximity to either the designated position or a position of the communication terminal.

### (Item 1-6)

The information processing apparatus according to item 1-4, further comprising an inferring unit configured to infer audio content having a high priority for the user, based on information indicating an operation history of audio content in the communication terminal, the operation history being acquired from the communication terminal.

### (Item 1-7)

The information processing apparatus according to item 1-6, wherein in a case where no audio content included within the predetermined range from the designated position is present, the providing unit provides the communication terminal with the content information of the audio content inferred by the inferring unit.

### (Item 1-8)

The information processing apparatus according to item 1-7, wherein in a case where no audio content included within the predetermined range from the designated position is present and no audio content inferred by the inferring unit is present, the providing unit provides the communication terminal with the content information of the audio content in accordance with a ranking determined, based on operation histories of a plurality of users.

### (Item 1-9)

An information processing method performed in an information processing apparatus including a storing unit configured to store access information for audio content to be provided from an external server for content provision, in association with information of an access condition for the audio content, the information processing method comprising:
acquiring position information of a communication terminal used by a user;
specifying the audio content that provides the communication terminal with access, based on the access condition for the audio content; and
providing the communication terminal with content information including the access information associated with the audio content specified.

### (Item 1-10)

An information processing system comprising an information processing apparatus and a communication terminal used by a user, wherein
the information processing apparatus includes:
   a storing unit configured to store access information for audio content to be provided from an external server for content provision, in association with information of an access condition for the audio content;
   an acquisition unit configured to acquire position information of a communication terminal used by a user;
   a specifying unit configured to specify the audio content that provides the communication terminal with access, based on the access condition for the audio content; and
   a providing unit configured to provide the communication terminal with content information including the access information associated with the audio content specified, and wherein
the communication terminal includes:
   a transmission unit configured to transmit position information of the communication terminal to the information processing apparatus; and
   display the content information of the audio content to be provided from the information processing apparatus on a display unit, and start reproducing the audio content of the external server.

### (Item 1-11)

A program causing a computer to function as each of units of the information processing apparatus of any one of item 1-1 to item 1-8.

### (Item 1-12)

A storage medium storing a program causing a computer to function as each of units of the information processing apparatus of any one of item 1-1 to item 1-8.

### (Item 2-1)

An information processing apparatus comprising:
a registration unit configured to register audio content created by a first user to be provided from an external server for content provision;
an acquisition unit configured to acquire either position information of a second communication terminal used by a second user or position information designated on the second communication terminal; and
a providing unit configured to provide the second communication terminal with content information including access information for the audio content, wherein
the registration unit acquires and registers the access information for the audio content and position information set to the audio content from a first communication terminal used by the first user, and
the providing unit provides the second communication terminal with content information including the access information for the audio content, based on either the position information of the second communication terminal or the position information designated on the second communication terminal, and the position information set to the audio content.

### (Item 2-2)

The information processing apparatus according to item 2-1, wherein the registration unit updates the position information set to the audio content, based on new position information from the first communication terminal.

### (Item 2-3)

The information processing apparatus according to item 2-1, wherein the providing unit further, before registering the audio content, acquires the position information set to the audio content, and provides the first communication terminal with the content information of audio content of another user set to a position within a predetermined distance from the position information.

### (Item 2-4)

The information processing apparatus according to item 2-1, wherein the registration unit registers a position of the first communication terminal in association with the position information set to the audio content.

### (Item 2-5)

The information processing apparatus according to item 2-1, wherein the registration unit registers a plurality of pieces of position information as the position information set to the audio content.

### (Item 2-6)

The information processing apparatus according to item 2-1, wherein the registration unit registers the position information set to the audio content to be sequentially changed between a plurality of pieces of position information.

### (Item 2-7)

The information processing apparatus according to item 2-1, wherein the registration unit registers a plurality of pieces of audio content created by the first user in association with each other.

### (Item 2-8)

An information processing method performed in an information processing apparatus, the information processing method comprising:
registering audio content created by a first user to be provided from an external server for content provision;
acquiring either position information of a second communication terminal used by a second user or position information designated on the second communication terminal; and
providing the second communication terminal with content information including access information for the audio content, wherein
the registering acquires and registers the access information for the audio content and position information set to the audio content from a first communication terminal used by the first user, and
the providing provides the second communication terminal with content information including the access information for the audio content, based on either the position information of the second communication terminal or the position information designated on the second communication terminal, and the position information set to the audio content.

### (Item 2-9)

An information processing system comprising an information processing apparatus and a first communication terminal used by a first user, wherein
the information processing apparatus includes:
   a registration unit configured to register audio content created by the first user to be provided from an external server for content provision;
   an acquisition unit configured to acquire either position information of a second communication terminal used by a second user or position information designated on the second communication terminal; and
   a providing unit configured to provide the second communication terminal with content information including access information for the audio content, wherein
the registration unit acquires and registers the access information for the audio content and position information set to the audio content from a first communication terminal used by the first user, and
the providing unit provides the second communication terminal with content information including the access information for the audio content, based on either the position information of the second communication terminal or the position information designated on the second communication terminal, and the position information set to the audio content, and wherein
the first communication terminal includes:
   an access information acquisition unit configured to acquire the access information for the audio content from the external server for the content provision; and
   a transmission unit configured to transmit the access information for the audio content and the position information set to the audio content to the information processing apparatus.

### (Item 2-10)

A program causing a computer to function as each of units of the information processing apparatus of any one of item 2-1 to item 2-7.

### (Item 2-11)

A storage medium storing a program causing a computer to function as each of units of the information processing apparatus of any one of item 2-1 to item 2-7.

The invention is not limited to the foregoing embodiments, and various variations/changes are possible within the spirit of the invention.

What is claimed is:

1. An information processing apparatus comprising:
a storing unit configured to store access information for audio content to be provided from an external server for content provision, in association with information of an access condition for the audio content;
an acquisition unit configured to acquire position information of a communication terminal used by a user;
a specifying unit configured to specify the audio content that provides the communication terminal with access, based on the access condition for the audio content; and
a providing unit configured to provide the communication terminal with content information including the access information associated with the audio content specified.

2. The information processing apparatus according to claim 1, wherein
the information of the access condition for the audio content includes position information set to the audio content, and
the providing unit provides the communication terminal with the position information set to the audio content specified.

3. The information processing apparatus according to claim 2, wherein the providing unit provides the communication terminal with the content information of the audio content, the access condition for which is satisfied by a position of the communication terminal.

4. The information processing apparatus according to claim 2, wherein
the acquisition unit further acquires, from the communication terminal, a designated position designated on the communication terminal, and
the providing unit provides the communication terminal with the content information of the audio content included within a predetermined range from the designated position.

5. The information processing apparatus according to claim 4, wherein the providing unit provides the communication terminal with the content information of audio content prioritized in order of proximity to either the designated position or a position of the communication terminal.

6. The information processing apparatus according to claim 4, further comprising an inferring unit configured to infer audio content having a high priority for the user, based on information indicating an operation history of audio content in the communication terminal, the operation history being acquired from the communication terminal.

7. The information processing apparatus according to claim 6, wherein in a case where no audio content included within the predetermined range from the designated position is present, the providing unit provides the communication terminal with the content information of the audio content inferred by the inferring unit.

8. The information processing apparatus according to claim 7, wherein in a case where no audio content included within the predetermined range from the designated position is present and no audio content inferred by the inferring unit is present, the providing unit provides the communication terminal with the content information of the audio content in accordance with a ranking determined, based on operation histories of a plurality of users.

9. An information processing method performed in an information processing apparatus including a storing unit configured to store access information for audio content to be provided from an external server for content provision, in association with information of an access condition for the audio content, the information processing method comprising:
acquiring position information of a communication terminal used by a user;
specifying the audio content that provides the communication terminal with access, based on the access condition for the audio content; and
providing the communication terminal with content information including the access information associated with the audio content specified.

10. An information processing system comprising an information processing apparatus and a communication terminal used by a user, wherein
the information processing apparatus includes:
a storing unit configured to store access information for audio content to be provided from an external server for content provision, in association with information of an access condition for the audio content;
an acquisition unit configured to acquire position information of a communication terminal used by a user;
a specifying unit configured to specify the audio content that provides the communication terminal with access, based on the access condition for the audio content; and
a providing unit configured to provide the communication terminal with content information including the access information associated with the audio content specified, and wherein
the communication terminal includes:
a transmission unit configured to transmit position information of the communication terminal to the information processing apparatus; and
display the content information of the audio content to be provided from the information processing apparatus on a display unit, and start reproducing the audio content of the external server.

11. A non-transitory computer-readable storage medium storing instructions for causing a computer to perform an information processing method in which an information processing apparatus includes a storing unit configured to store access information for an audio content to be provided from an external server for content provision, in association with information of an access condition for the audio content, the method comprising:
acquiring position information of a communication terminal used by a user;
specifying the audio content that provides the communication terminal with access, based on the access condition for the audio content; and
providing the communication terminal with content information including the access information associated with the audio content specified.
